(19) United States
(12) Patent Application Publication
(10) Pub. No.: US 2020/0167868 A1
(43) Pub. Date: May 28, 2020

(54) System and method for analyzing and evaluating the investment performance of funds and portfolios

(71) Applicant: Guy Mineault, Quebec (CA)

(72) Inventor: Guy Mineault, Quebec (CA)

(21) Appl. No.: 16/699,066

(22) Filed: Nov. 28, 2019

Related U.S. Application Data
(60) Provisional application No. 62/772,433, filed on Nov. 28, 2018.

(51) Int. Cl. G06Q 40/06; G06F 16/904

(52) U.S. Cl. CPC G06Q 40/06; G06F 16/904

(57) ABSTRACT

A system and method for analyzing and evaluating the investment performance of funds, ETF's and bonds as well as many algorithms and processes and methodologies are described.

### CROSS-REFERENCE TO RELATED APPLICATIONS

This application claims priority on U.S. application No. 62/772,433 entitled “System and method for analyzing and evaluating the investment performance of funds” filed on Nov. 28, 2018.

### FIELD OF THE INVENTION

The present invention generally relates to systems and methods for analyzing, evaluating, enhancing and balancing funds and portfolios of funds in regard to the investment performance of all types of Funds, ETF's and bonds.

### BACKGROUND OF THE INVENTION

Individuals and professionals in financial services must evaluate and analyse through a very visual display of the different decision indicators on the performance, return, risk, and many other measures and comparators. More specifically, our technological objective was to develop a platform with a cloud architecture to collect, update and communicate large amounts of data from a very large number of funds (nearly 40,000) to different electronic devices that investors use, while allowing them to carry out advanced research on the data. In the industry, fund valuation and valuation of fund portfolios are common, however, they transmit the information in the form of rough mathematical indicators too difficult to interpret or not relevantly based on the analysis conducted.

Other existing system limit themselves to “buying” databases in order to analyse funds within what is called the “fundamental approach”. That approach is now outdated for all purposes because the approach always presumes that there is a close relationship between a fund and its index of reference. This is no longer the case for a myriad of reasons like the Quantitative Easing (QE) of moneys practiced in the US, Japan, and Europe, the firm buybacks of their stocks, the speculators that buy the “dip” and sell the “top” (short selling), the role of the FAANG titles, etc.

### The Traditional “Fundamental” Approach.

In early computer days, the commodore 64 was a “hot” computer and it satisfied most of our computer needs at that time. However, it would no longer be appropriate today because what was suitable then is no longer suitable today. It's the same thing when it comes to analysing, evaluating, enhancing and balancing funds in a portfolio. The “fundamental” approach (the equivalent of the commodore 64) is no longer suitable and is of little use today. We need another approach because Main Street is disconnected from Wall Street and the funds disconnected from their normal reference indices for a number of reasons some of them shared in the previous paragraph. In addition, there are major changes in the geopolitical, financial, and economic environments. That is why we have developed this innovative, practical and useful approach.

We can measure the relationship between a fund and its index of reference with what is called the coefficient of determination. The coefficient of determination can be found with the following formula: R2=MSS/TSS=(TSS−RSS)/TSS, where MSS is the model sum of squares (also known as ESS, or explained sum of squares), which is the sum of the squares of the prediction from the linear regression minus the mean for that variable; TSS is the total sum of squares associated with the outcome variable, which is the sum of the squares of the measurements minus their mean; and RSS is the residual sum of squares, which is the sum of the squares of the measurements minus the prediction from the linear regression. To be statistically significant and to correctly permit the interpretation of measures such as alpha, Treynor, beta, etc. . . . , the value of the coefficient of determination has to be greater than a predetermined value such as 85%. Then we can say that the index explains 85% of the variation in the funds return or standard deviation, or upside or downside capture ratio, etc. If the coefficient has a value of 55%, then the index explains only 55% of a fund's variations and most of the values of the TMP (theory of modern portfolio analysis) are useless as indicators. It is important that the index explains at least 85% of a fund's variation because of the statistical significance of the values of alpha, beta, Treynor, etc. depend on that relationship. If the coefficient is less than the 85%, then we can come to choose funds that we should not have or to not to choose funds that we should have. This is what we call errors of type 1 or type 2. And this can lead to very important monetary losses.

For the past years Main Street has become unconnected from Wall Street for all kinds of reasons, and almost all funds are no longer connected to their normal indices of reference. At this time, we can say that about only 8% of funds have R squares (coefficient of determination) that are greater than 85% and the fundamental approach to choose funds can very easily lead us to errors of type 1 and type 2. When it is less than about 85%, choosing funds with habitual measures of the modern portfolio theory approach can lead to make two types of errors. Error of type 1, is to choose a fund we should not have, because it will lose more than others in its category or error type 2, is to not choose a fund that we should have, since it is well performing especially in a down market.

Moreover, in the traditional fundamental approach, we presume that all the measures have the same weight or importance in selecting good funds. This is simply no longer true. Some measures like alpha, have lost most of their predictive power. Of the 40 or so measures in modern portfolio analysis, some are now much more important than others and others, less important.

### SUMMARY OF THE INVENTION

The objective of the invention is to provide a platform available in a SaaS model which simplifies the evaluation and selection of investment funds and portfolios.

The prior art approach is no longer as relevant as it was in the past and we had to invent other approaches to automatically identify top performing funds and separate them from poor performing funds. That is why we had to find a new system and method to better analyse, and evaluate the performance investment of funds, ETF's and bonds and to be able to act accordingly.

In a first aspect there is provided a system for analyzing and evaluating the investment performance of funds or portfolios thereof comprising:
a) a risk/return graphic having four quadrants in which the lower right-hand quadrant depicts poor performing funds, the lower-left hand quadrant depicts better performing funds, the upper left-hand quadrant depicts the best overall performing funds and the upper-right hand quadrant depicts high risk and high return funds for people who are risk takers,
b) a dashboard comprising the following sections:
   i) a risk/return section,
   ii) a risk management section.

In a further aspect, a method is provided to A method for automatically analyzing and evaluating the investment performance of funds or portfolios thereof using a computer system comprising the following steps:
a. obtaining a plurality of data points from existing databases relating to each fund,
b. using the data points to compute the at least the following measures for each fund:
   i. the coefficient of determination between said fund and its index of reference,
   ii. its standard deviation,
   iii. the value of its asymmetry,
   iv. its relative strength indicator,
   v. two of its moving averages,
   vi. the rate of return,
c. generating a risk/return graphic having four quadrants in which the lower right-hand quadrant depicts poor performing funds, the lower-left hand quadrant depicts better performing funds, the upper left-hand quadrant depicts the best overall performing funds and the upper-right hand quadrant depicts high risk and high return funds for people who are risk takers,
d. generating a dashboard comprising the following sections:
   i. a return/risk section,
   ii. a risk management section,
e. assigning one of a plurality of colors to said return/risk section said color being selected as follows:
   i. a first predetermined color if the fund is located in the upper left-hand quadrant,
   ii. a second predetermined color if the fund is located in the lower right-hand quadrant,
   iii. a third predetermined color if the fund is located in the lower left-hand quadrant,
   iv. a fourth predetermined color if the fund is located in the upper right-hand quadrant.
f. assigning one of a plurality of colors to said risk management section, said color being selected as follows:
   i. a first predetermined color if the risk level is equal or lower than a first predetermined value,
   ii. a second predetermined color if the risk level is equal or greater than a second predetermined value,
   iii. a third predetermined color if the risk level is greater than said second predetermined value and lower than said first predetermined value

### The Invention Analyzes Differently

As we will see later, in our new system and method, we do not compare funds with now irrelevant indices, but with their peers, according to categories, sectors or families. We compare skiers with skiers and swimmers with swimmers.

This means that our system and method use a new approach, useful, relevant and practical and not at all easily reproduced in most of its innovative aspects.

Not only do financial advisors often suggest poor performing funds to their clients (based on the existing fundamental approach and/or the TMP approach), but the investor clients will also often buy such poorly performing funds thinking that they are sound. This can lead to funds that will lose considerably in value when the market falls and take a long time to recover.

One of our challenges was to limit the use of numbers in the results but rather use readily recognizable visual identifiers to do so. Although this seems easy to do, in reality it was a great challenge. The generation and management of all of such visual identifiers via an advanced search engine while maintaining a user-friendly format complicates the development of such a platform. In addition, the very high volume of data increases the time to transmit, load, process and store it. However, it is essential that access to information be as quick as possible to ensure a consistent and stable use of the platform. The volume factor must also be taken into account so as not to exceed the local storage limits of devices, especially mobile devices. Therefore, research was required to optimize time and data loading locally to allow quick access to the search results, tools, filters and scheduling. The implementation of a cloud platform, deployed on a cloud service such as the Amazon™ service requires an architecture in the form of modular microservices, converted into templates, such as AWS CloudFormation™ templates. The microservice model allows to administer different environments by dividing the load of the platform between entities to various functions as a microservice responsible for the management of access to users, while another is dedicated to the performance indicators. In order to manage different microservices, the use of a microframework such as AWS Chalice™ is necessary. Nevertheless, at the level of the microservices update, this tool was missing because it does not allow to receive the output data from the microservice resources (stacks) to insert them in other resources.

This limitation made it necessary to perform the microservices updates manually. In this context, the automatic update of the entire application via the various microservices by ensuring the reliability and integrity of data within the system was inadequate.

We focused on the automation of updating the entire application from any of the microservices. For example, in the event of an update at the microservice level responsible for managing user access, the updated data will also be modified with other microservices such as those responsible for the fund's performance indicators. We developed a tool to automatically modify the CloudFormation™ templates before deploying them which we call Octocorn™. This tool was developed to generate CloudFormation™ templates (in anticipation of future updates) and return the URL before creating new stacks. Thanks to Octocorn™, the new version of a microservice was available on the entire application without any manual intervention.

Nevertheless, this method caused errors in some deployments at the CloudFormation™ level. Indeed, the resource limit assigned to CloudFormation™ was quickly achieved with the generation of a large number of templates. We then added a support module for all the templates generated thereby limiting the amount of resources allocated. We have since verified this iteration.

We dealt with the problem of the display time of more than 100,000 items on the platform including also the different filters and scheduling chosen on the client side.

We developed tables with columns allowing for fuzzy type research which would simplify the search engine research. The response time being greater than 10 seconds, we still needed to optimize the search parameters of the tool with stricter criteria. The results obtained were similar to the first iteration leading to a hypothesis about the use of virtual table which consisted in keeping in memory all the data but only display those that are needed. Thanks to this development to the restriction of the search parameters, the user could work offline and change the display (drag and drop, addition of checkbox components) with a response time of less than 3 seconds.

Finally, work was undertaken to enable users to easily load the data available on the application from their different devices, to perform searches, apply filters or order the data locally. So, the data is now loaded by the API and stored in local storage to allow searching in memory at each update. The local storage being limited for several types of devices, including mobile phones, the loading time of the data remained too long for a regular use, with a duration for total loading greater than three minutes and increasing depending on the quality of the connection.

We then saved the data in the indexed database of the device and where the API returned a downloadable file to optimize the download speed. Despite a loading time that now oscillated between 30 and 45 seconds, it was necessary to reduce it to facilitate the use of the application.

We then developed a new loading method that emits queries in two phases. A first step is dedicated to downloading essential data for display a basic visual, for example by converting data into the four colors that are red, green, yellow and orange. Then the second step recovers the data remaining and would allow more advanced display. Although this method has allowed to reach a download time of less than 10 seconds, it resulted in many unnecessary downloads.

So, we then generated different versions of data to download only the data that has been modified in the backend. This solution not being possible for devices that do not have an indexed database, the search for a more generally applicable solution was pursued.

We then invented an approach to enhance and balance fund portfolios that is very much appreciated by financial advisors for it also allows them to save about 2 to 3 hours of work compared to existing methods. The sections hereunder on improving and balancing portfolios for a good explanation of this. We have also generated arguments that allow a financial advisor to identify weak elements in a competitor's funds or fund portfolios and underline the strong points of the funds or fund portfolios that the advisor is suggesting as a replacement. These arguments are based on data or ratios or measures that we sometimes have also invented (such as rate of recovery ratios, measuring TMP measures with the category or sector averages, weighting measures according to their importance in a decision-making process, etc. . . . as explained later) and that are an integral part of the system.

We have also added a series of arguments that an advisor can use to convince a prospective investor to do business with him/her rather than his/her former advisor. Some examples of this are as follows. The prospective client has a return of 10% on a fund as does the fund proposed by the soliciting advisor. However, the soliciting advisor can tell the prospective client things like “were you aware that your fund would lose much more than the one I'm proposing and take longer to recover? Or did you know that your fund has a negative momentum and mine a positive one? Or did you know that according to the quartile of the price/earnings ratio, your fund has probably reached its peak value and mine is at a trough value? Arguments like these need the support of the software to show that these arguments are true. But these kinds of arguments are very useful to help convince a potential investor to transfer funds from his/her current advisor to the new advisor.

And finally, we have also added to the system a mobile application (available on existing app stores such as those operated by Apple™ and Google™) that allows the financial advisor to reach out to potential clients in a unique way. When the advisor (say advisor A) sends an example of the mobile application to a prospective investor, that investor will be able to evaluate by himself the investment performance of his funds in terms of return and risk. He can enter the code of his fund or the name of his fund in the search field of the application and it will show the investor where his fund stands in terms of potential return and risk compared to other funds in the same category or sector. He will see if the fund is red (poor), yellow (for the conservatives), green (strong) or orange (for the more aggressive investor) in color. We add more explanations to the colors, later on. No other mobile application does this. And if the investor is not happy with the funds his current advisor has sold him (say advisor B), he can send a message to the advisor A with the tool provided and ask him to enhance his portfolio. The prospective investor will always direct his queries to the advisor that has sent him the mobile application because the applications will be coded with a code that identifies the advisor A, in this case. This is a unique approach.

At the moment of writing this text, there are over 38,000 funds available for Canadians to buy and just as many in the United States. These are divided in 12 different types of funds, 11 sub sectors, 56 different categories, and 216 families (in Canada). It really is not easy to separate the better funds from the worse ones. And especially with some of the things bring said in the industry that are simply not true, half truths, or even exaggerated. These things do not only happen in the construction industry. Furthermore, each month the system retrieves over 300 data points in order to feed the system. The data comes from data providers such as Thomson and Reuters™. In fact, these data points are a selection of over 900 different data points which are currently available on a monthly basis. To list these data points here would take over 24 pages. Our system makes it easier for financial advisors as well as investors to separate the better funds from the worse ones.

This is what our invention is all about. It has over many innovative components or functionalities including:
a. the invention analyzes differently,
b. automation of updating the entire application from any of the microservices,
c. enable users to easily load the data available on the application from their different devices,
d. saved the data in the indexed database of the device and where the API returned a downloadable file to optimize the download speed,
e. methodology for choosing funds in accordance with colors on the risk/return graphic,
f. dashboard incorporating:
   i. a CRM specifically designed for fund analysis,
   ii. a “Know Your Customer” component that is specifically designed for funds,
   iii. a “compliance” component specifically designed for the funds and which responds to various aspects of the law and the expectations of Securities Regulators,
   iv. special innovative features in the client section including: client selectable short term or long-term objectives, establishing a portfolio for each objective and tracking each objective,
   v. an “organization” component that allows leaders of an organization to share various elements with their current and potential customers,
   vi. mobile apps that allow investors to independently evaluate their funds in a manner never before available for them,
g. four ways to evaluate funds, being:
   i. fundamental evaluation,
   ii. potential return, risk and volatility evaluation,
   iii. momentum evaluation,
   iv. risk management,
h. flow chart for choosing funds,
i. new definition of a good performing fund,
j. method of enhancing and balancing fund portfolios
k. automatic portfolio improvement,
l. asset distribution balancing,
m. portfolio optimization to maximize the return and minimize the risk while respecting the investor's asset distribution,
n. novel lead creation method,
o. automatic generation of selling arguments,
p. calculation of TMP measures like alpha, beta, Treynor, etc. for each fund by using the variations of their respective categories rather than using the variations of the normal indices,
q. use of asymmetry measurement in risk management,
r. putting both the median and the average on a risk/return graphic.

These features are practical and very useful for all who use the system, easy to use and saving a lot of research time. The system provides results which are neutral, non-biased and independent from any fund managers.

### BRIEF DESCRIPTION OF THE DRAWINGS

The above and other aspects, features and advantages of the invention will become more readily apparent from the following description, reference being made to the accompanying drawings in which:

FIG. 1 shows the overall view of an embodiment of the invention and its applications.

FIG. 2 shows an example of a risk/return graphic in accordance with the invention.

FIG. 3 shows the different files that can be looked after in respect to the client information (KYC) of column 6, and the compliancy files in columns 1 to 5.

FIG. 4 shows a view of our overall dashboard as well as our invented methodology to analyse and evaluate funds, ETF's and bonds as well as some of our processes and methodologies, that are of our innovative thinking.

FIG. 5 shows our invented methodology with respect to the evaluation of four features that enable us to analyse and choose funds, ETF's and bonds.

FIG. 6 is an example of a screen showing the evaluation of a fund using the invention.

FIG. 7 is an illustration of a screen appearing when the ‘improve’ button of FIG. 6 is selected.

FIG. 8 is an illustration of a screen appearing when a new fund is selected for its potential addition to the portfolio of FIG. 6.

FIG. 9 contains examples of graphs divided in quadrants graphically showing the showing the results of the TMP measurements of different funds.

FIG. 10 is a graph showing an example of two funds with different asymmetries.

### DETAILED DESCRIPTION OF THE PREFERRED EMBODIMENT

A novel investment analysis and evaluation system and method will be described hereinafter. Although the invention is described in terms of specific illustrative embodiments, it is to be understood that the embodiments described herein are by way of example only and that the scope of the invention is not intended to be limited thereby.

We have created and invented dozens of graphs, tables and relationships that our competitor's do not have and this allows financial advisors and/or the investor to easily identify the funds, ETF's or a bonds investment performance.

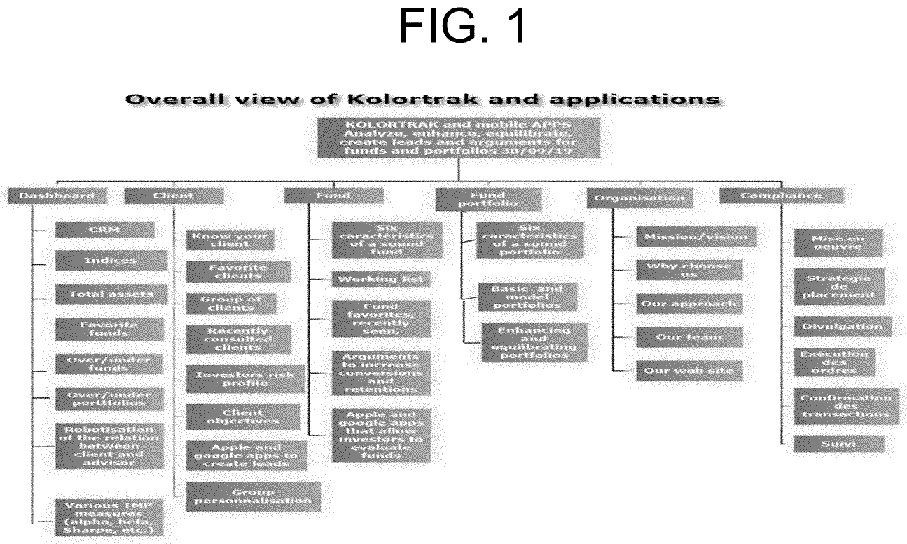

In column one of FIG. 1, we see the main element of the dashboard. In the second column we see the main things pertaining to the investor client. In the third column we see things like six characteristics that make for a good performing fund, as well as the place for the mobile application and the advisor arguments that we will see later on. In the fourth column we see some element related fund portfolios including important elements such as improving a portfolio (more return with less risk) and balancing it afterwards so that it complies with the investors risk profile. In the fifth column we see things that may be said about the organisation (why do business with us etc.) This is not innovative, but is part of the whole methodology used to help the advisor better serve his client. And finally, the last column has to do with the important compliance aspect of selling funds.

Methodology for Choosing Funds in Accordance with Colors on the Risk/Return Graphic.

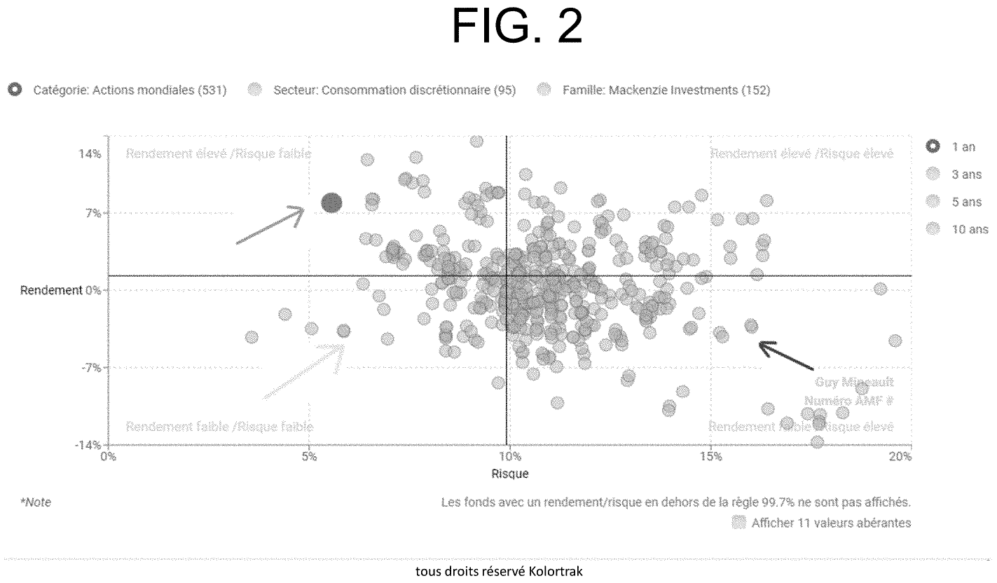

FIG. 2 shows an example of a risk/return graphic. We have not invented such a graphic but we have invented how to represent funds and portfolios in color by category, sector or family. It is much easier to read and find where an investors fund is than by just using numbers or mathematical formulas. Our system and method for choosing funds in accordance with such graphics, is unique.

Very few financial advisors have a Master's degree in finance and/or have gotten to know what terms such as alpha, beta, Sortino, Calmar, information ratio, etc. . . . mean and how to interpret them. Our approach allows financial advisors and investors to get to know a fund's performance according to different colours rather than having to know all the above-mentioned measures and meanings.

FIG. 2 is but one of dozens that are used to evaluate and analyze funds. The horizontal line is the average return of funds in that category. The vertical line is the average standard deviation of funds in that category. Every circle represents a fund in that category. If a fund has a red colour, it is because it has a smaller return and a greater risk of losing money should the stock market fall, than the average fund in that same category. If a fund has a yellow colour (bottom left quadrant), it is because it has a smaller return than the average fund in its category but less risk or volatility than the average fund. If the fund has a green colour (top left-hand corner), it means that the fund has a greater return than the average with less risk or volatility. Ideally, advisors and consumers should be seeking out funds with a green colour and shun those with a red colour. And finally, if a fund has an orange colour (top right-hand corner), it has a greater return than the average but a greater volatility. Some funds in this quadrant can be OK for an aggressive investor. We can easily compare fund performance according to returns and standard deviation, from one year to ten years.

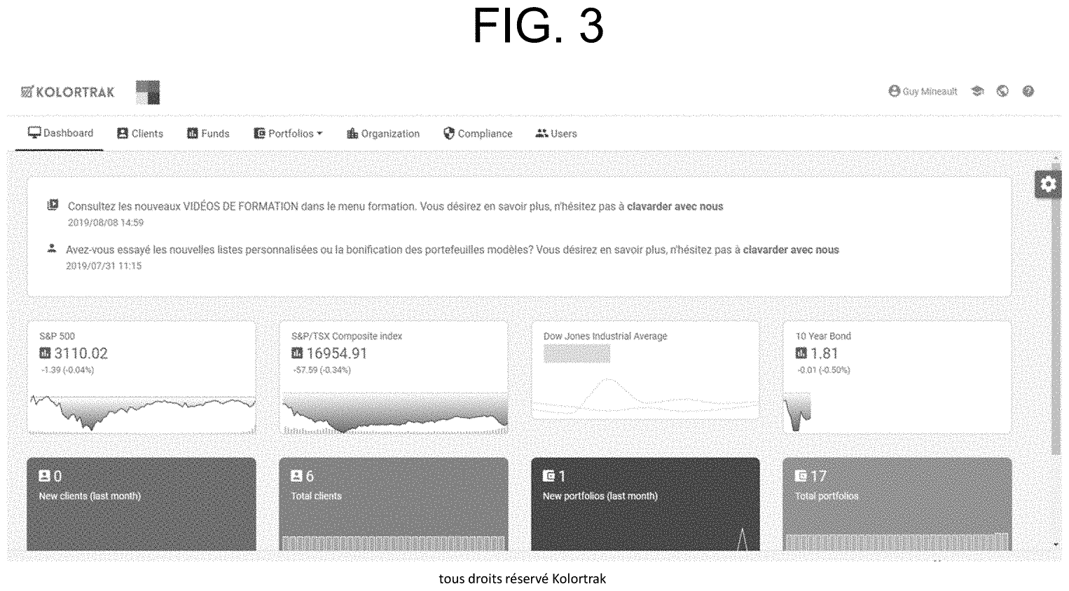

The Dashboard. No one has a dashboard like ours with all its different functionalities. As can be seen in FIG. 3, the dashboard can be personalized, and an advisor could have a section (rectangle) with his say 30 favorite funds, or five favorite portfolios. He could see that in his 30 favorite funds, 26 are green and 4 are orange. When he updates the latest data on fund risks and returns, he may still find that 26 of them are green and 4 are orange. In this case he doesn't have to make any fund adjustments. He may take time to go out and play golf or look after his family or do some client prospecting. The personalisation of the color of his funds has saved him a lot of time because he always has the resulting colors in front of him. It is a simple and productive way for him to follow the evolution of his funds. We are making save some search time. This type of example may be repeated with portfolios, types of funds, types of customers, etc. The dashboard also has a CRM specially designed to serve the basic needs of the advisor. It allows him to share information with other advisors, etc.

Above is the dashboard and on the right hand side of the word dashboard, we have buttons for quite a few basic functions that the advisor needs. It incorporates a CRM specifically designed for fund analysis.

It incorporates a “Know Your Customer” component that is specifically designed for funds. The investor profile questionnaire that Securities Regulators want, can be personalized and fitted to a firm's needs.

It also incorporates a “compliance” component specifically designed for the funds and which responds to various aspects of the law and the expectations of Securities Regulators.

It also has special innovative features in the client section. For example, a client can determine different short term or long-term objectives (send my child to university in 12 years or buy a new car in 5 years, etc.) and have a portfolio for each objective and be able to follow them easily to see if he/she is on track with the objectives.

It incorporates an “organization” component that allows leaders of an organization to share various elements with their current and potential customers. It incorporates apps like those found in the Apple store and Google play for the investor that allows them to independently evaluate their funds in a manner never before available for them.

### Four Ways to Evaluate Funds.

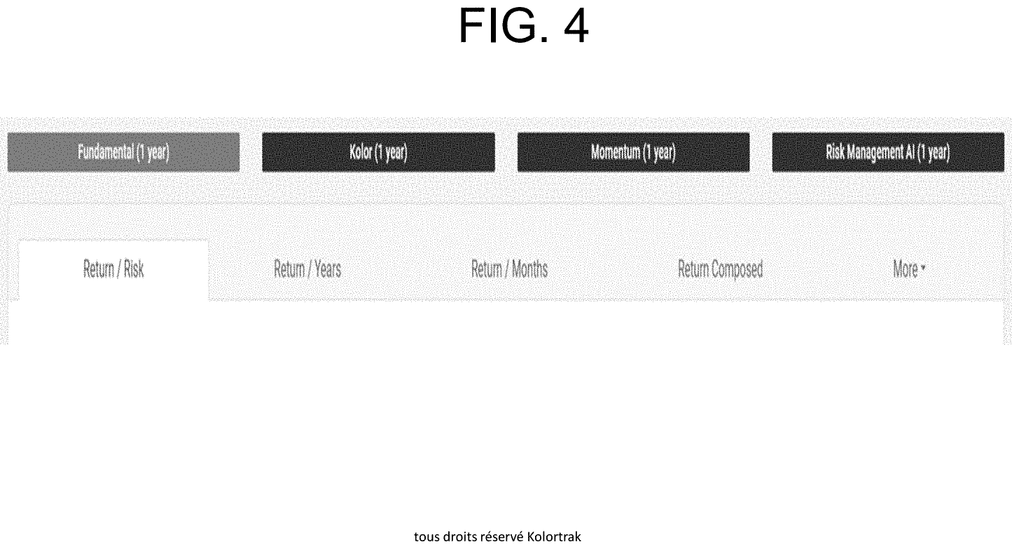

Nobody else does this and it is unique, practical and very appreciated by financial advisors as well as investors. We can see these four ways in FIG. 4. The most common way used to evaluate funds is using the Fundamental approach. We can see this in the four action buttons described below. They are briefly explained now, but we will expand on them further on.

The first button is the Fundamental button. It allows the user to know if he/she can choose funds according to the TMP measures (theory of modern portfolio measures). If the button is green that means that the coefficient of determination is equal or greater than the selected threshhold, for example 85% and the alpha's, beta's and other measures are statistically significant and we can choose funds according to the values of these measures. If the button is red, that means that the TMP measures are not statistically significant and that choosing funds on the basis of the TMP measures could cause two types of Errors. An Error of type 1, is choosing a fund which should never been have chosen for it could very well lose more than other funds in the same category or sector. An Error of type 2, is not having chosen a fund that should have been considered and would probably perform well in a stock market crash.

The second button, the Kolor™ button. This button is in one of four colors. If Red, the fund has less potential return and a greater risk and volatility than other funds in the same category or sector. If Yellow, it has less potential return with less risk than the average in that category or sector. If Green, the fund has a greater potential return together with less risk or volatility than the average fund in the category or sector. Advisors should usually recommend funds with green colors. And finally, if Orange, a fund has a greater potential return than the average for that category or sector together with greater volatility. In essence, an advisor should never recommend funds that are in the red segment. They should not exist. The Kolor button is an action button that is really appreciated by financial advisors and their customers.

The third button is the momentum button. It allows the user to evaluate a fund's momentum. We have developed a method integrating up to 15 different measures that allow the user to follow a fund's momentum. As will be explained later, these measures are weighted in importance. If there are a predetermined number of these measures (for example 10 or more out of fifteen measures) that are positive, the button will be of a green color and that signals a buy or hold if the fund is already part of the portfolio. If the color is red, that means that 5 or less of the measures are positive. Thus, one should avoid buying the fund. If the color is yellow, that means that there are between 6 and 9 positive measures and that one should be prudent in choosing that fund. The methodology used here is unique. No one else of our competitors has such a button. We will describe it fuller later on with measures such as moving averages, RSI measures, trends, stock rotation in the fund, etc. that are not new because they are used in analyzing stocks and foreign exchange markets, but we have had to adapt them to funds and that was no easy feat. We have thus invented how to adapt some measures to our system. The RSI is one of the best indicators for detecting trends and reversals of trends. The formula=100−(100/1+RS) or RS=Number of bullish days/Number of bearish days. If the number of ups and downs is equal, the RSI=100/1+1/1=50. If there are 2 times more bullish than bearish moments RS=100/(1+2/1)=3, and the RSI=100−33.33 or 66.66 and so it's time to sell because the fund has been overbought. If there are twice more drops the RSI=100−(100/(1+1/2)), RSI=33.33 so the time to buy because it has been oversold. The lower the RSI, the more it indicates that it is worth buying the fund. The RSI is usually calculated over a period of 14 days.

One of the equations that helps in identifying the momentum of a fund is the following:

$$MDD = \frac{Trough Value - Peak Value}{Peak Value}$$

That is why one of our other equations looks like the following where we can accord different weights to different variables. For example, 15 variables may be used:

$${Ratio}_{t} = \frac{{\sum }_{i = 1}^{N} [ {P}_{i , t} \text{?} {V}_{i , t} \text{?} {FX}_{i , t} ]}{{M}_{c , t}}$$

$$\text{?} \text{indicates text missing or illegible when filed}$$

where

Σᵢ₌₁^{N}/ i represents the number of measures from 1 to 15.

P_{i,t} represents the weight of measure i at time t

V_{i,t} represents the value of the measure i at time t.

FX_{i,t} represents the exchange rate for the measure at time t.

M_{c,t} represents the average for the category, sector or region.

We have not invented theses equations, but we are the only ones that have applied them in the context of analysing the momentum of funds. The application is not at all as easy as it looks, because we have to use different techniques to evaluate, such as nonlinear and linear regressions, variance analysis, consider category and/or sector limits, etc.

Moreover, we have not invented the technical approach widely used in foreign exchange analysis, but we have invented on how to adapt the approach with regards to funds.

And we have not invented the RSI approach used in analysing stocks on the stock market, but we have invented on how to apply the relative strength model to funds. In both the technical and relative strength approaches we have had to use ingenuity to adapt them to funds.

One easy to understand example of momentum can be described as follows; Suppose two funds that have the same average return over three years. Fund A had a 15% return on year 3, 10% on year two and 5% on year one. Fund B, had a 5% return on year three, 10% on year two and 15% on year one. Which fund has a positive momentum? Evidently fund B even though both funds have the same average return over 3 years. This is a simple example of one of the 15 different measures of momentum that are incorporated under the momentum button. We have also adapted a big data approach to help us better evaluate and analyze the investment performance of the funds.

One of the variables used in our momentum button has to do with the technical approach used in analyzing stocks, bonds and trading in foreign exchange. We have not invented the technical approach analysis, but we have invented on how to adapt the approach with regards to funds. This was not easy to do but we have succeeded, and it does tell us if we should buy, hold or sell a fund. Nobody else does this as applied to funds. For example, we calculate the 200 day moving average of a fund's value and compare this with say the 50 day moving average or the 20 day moving average. If the trend of the 50 day or 20 day moving average of the fund is superior to that of the 200 day moving average, the we can say that the fund has a positive momentum. That is, the price of the 50 days and the 20 day moving average is superior to what has been happening in the last 200 days. However, if the 50 day and 20 day moving averages show a declining trend with respect to the 200 day moving average then we can say that the fund has a negative momentum. Our competitors are not able to do this because they only provide month end data and it is not easy to establish relevant trends using 200 month versus 50 month and 20 month moving averages. 200 months is too long a time span to be useful. We use daily data.

Our system helps the user to better and more easily evaluate and analyze the investment performance of the funds. The approach is creative but simple. We do correlations on more than 800 data variables that we get from the firm Thomson Reuters™ and we try to see if we can find trends, relationships between variables that make sense. We can thus find patterns that we were unaware of. As an example, we have surprisingly discovered that for some funds, January and February are months where we should sell those funds because they reach a high value in those months. And analyzing the big data allows to find that we should buy these exact same funds in the month of June. This helps the advisor in better counselling his client by indicating when he should buy or sell that particular fund. There are currently over 38,000 funds available for Canadians to buy and data is available to go back 10 years (120 months). If it were not for this approach that allows us to analyze such big data, we would never have found some of those relationships. No one human can cope with 38,000 funds times 120 months and uncover patterns. But our system allows us to do so.

We can give you another example of the use of our system on our big data base. By looking at how well diversified portfolios look like, we have surprisingly found that the value of the Sharpe ratio of a portfolio must be greater than the value of the Sharpe ratios of each of the individual funds in the portfolio. This is interesting because in todays geopolitical and speculative stock market environment, it is difficult to come up with a well diversified portfolio. We have discovered a methodology that statistically makes sense. This will be a useful input when helping an advisor with the diversification of his portfolios.

The fourth button has to do with risk management. In the investment field, the risk measure that is normally used is the standard deviation. However, for it to be statistically significant when used with other measures like the Sharpe and Sortino ratios, the standard deviation has to be normally distributed. But they are no longer normally distributed for funds or ETF's because most funds are now disconnected to their normal indices and because the standard deviations when returns are increasing are not equal to the standard deviations when the returns are decreasing. That is why to select the color of this button we use a plurality (in this example 11) different weighted measures (liquidity ratios, quartile of price/earnings, quartile of price to book ratio, rotation ratio, quartile of standard deviation, the value of the asymmetry, the value of its kurtosis, current value of the fund in the last three year interval, number of stocks in the fund, a recovery ratio like the upside capture ratio over the downside capture ratio, the funds Sharpe ratio divided by the Sharpe ratio of the category or sector) that better evaluate a funds risk, volatility, loss ratio and time for recovery from a loss. If the button is green, that means that there are more than a predetermined number of measures (in this example 8) that indicate the fund is less at risk than the average in its category or sector. If it is yellow, it indicates that between 5 and 7 measures indicate that it is a bit riskier and if it is red, then that funds is at a great risk of greater losses than the average fund in its category or sector. The system does correlations with our big data (38,000 funds over 120 months) to see how funds react to periods such as when interest rates increase (or decrease), or there were major changes in fiscal policies, etc. What types of funds or what particular funds were the most at risk, changed the most, had the most volatility during such changes (for example, as interest rates change). There is too much data to be able to do this individually.

We have found that two funds that have the same average return will not necessarily react the same way if the market crashes. We have developed methods that allow the system to distinguish by how much a fund may lose as well as how long it may take to recover. Sometimes a fund with a smaller average return will do better in a down market (a loss of 10% say) and recover faster than a fund that has a greater average return but will lose more (a loss of 50% as an example).

The maximum loss. Also known as Max Drawdown, this is the other risk approach most commonly used and the simplest to understand for the investor. It will determine the loss that would have been suffered by the investor if he had the misfortune to invest at the highest and resell the lowest over the period considered. It is also associated with the recovery time, which is the number of days the product has set to return to its historical high after going through the lowest:

$$MDD = \frac{Trough Value - Peak Value}{Peak Value}$$

The Tracking Error. Tracking error is based on the same principle as volatility but is related to the market. This concept is a little less intuitive than for the alpha: it is a matter of measuring whether the fund has had a behavior similar to that of the market (weak Traking Error) or on the contrary if it had an atypical behavior and different from that of the market (high Traking Error). In the first case we will talk about passive or “benchmarked” management. In the second case we will talk about active or opportunistic management.

The information ratio. This is the translation of the Sharpe index into a relative version, that is, the division of alpha by Tracking Error (relative return divided by relative volatility). Although not at first sight intuitive, this ratio is important because it is a good indicator of the quality of fund management and is the basis of a number of fund ratings. Why? In concrete terms, this information ratio measures the fund's ability to outperform while remaining within the market. This means that the fund manager has managed to create wealth regularly by not taking positions too atypical or through too erratic behavior. It is the mark of a robust and quality management in the long term with performances that are not likely to be reversed at the first fluctuation coming from the market.

Again, we use the two of the same equations used in the momentum (two of a multiple of equations). For a brief explanation of the functioning of these two equations, please read in the momentum section.

$${Ratio}_{t} = \frac{{\sum }_{i = 1}^{N} [ {P}_{i , t} \text{?} {V}_{i , t} \text{?} {FX}_{i , t} ]}{{M}_{c , t}}$$

$$\text{?} \text{indicates text missing or illegible when filed}$$

### We Have Invented a Method for Selecting Funds

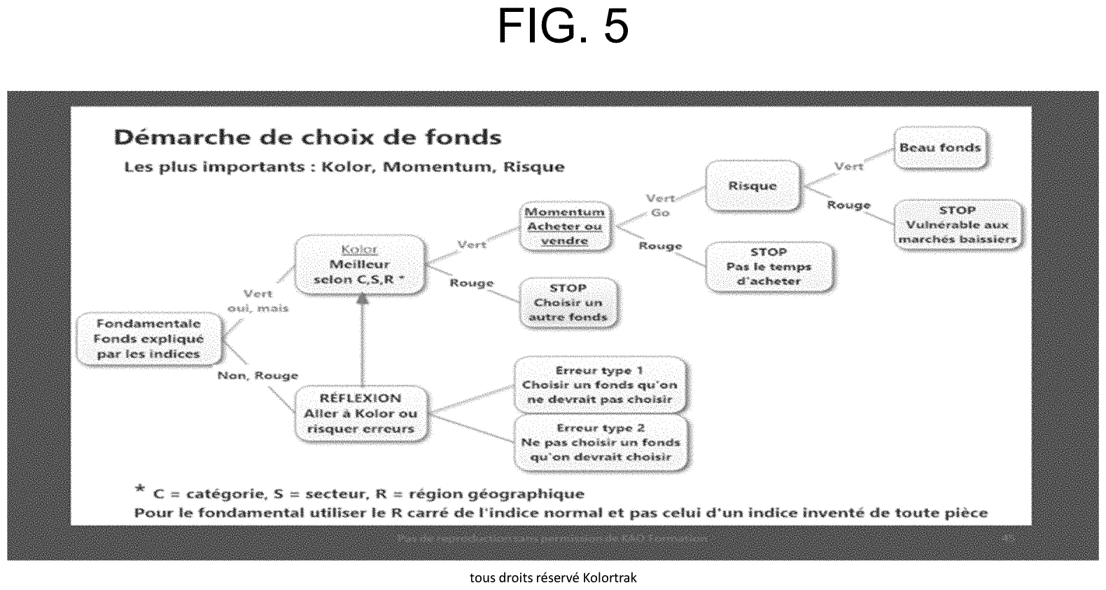

The decision chart shown in FIG. 5 is really appreciated and helpful for financial advisors for it is a summary of what can be done with the four afore mentioned buttons.

Our Invention of What Constitutes a Good Performing Fund

We define a good performing fund, ETF or bond as follows:
1) Decreases less often than its index of reference,
2) When it does decrease, it decreases less,
3) When its index increases, the fund, ETF rises as much if not more,
4) It has a return superior to that in its category or sector,
5) It has a positive momentum,
6) Its downside risk is smaller than that of other funds in its category or sector.

Here are the measures and the values we need for a fund to be able to behave according to the above characteristics:
Alpha has to be greater than zero,
Beta smaller than one,
Treynor greater than 20,
Sharpe greater than 2 or at least greater than the Sharpe of its reference (index, category or sector),
Positive momentum as defined above,
A positive risk management (green color).

### Enhancing (Improving) and Balancing Fund Portfolios

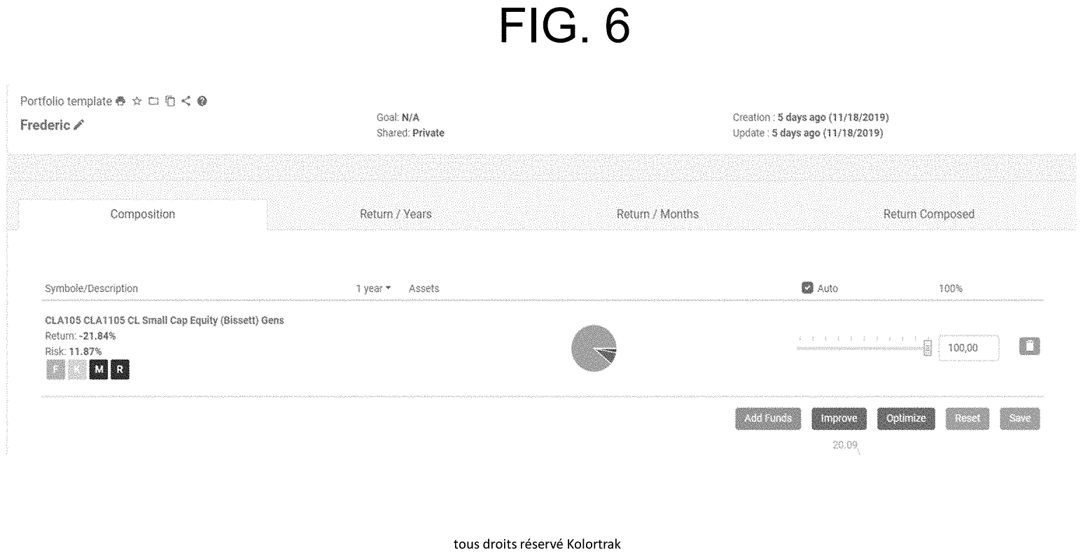

We have invented a new, simple and practical way for financial advisors to enhance funds and portfolios. It consists of creating an investor's existing fund portfolio In the example shown in FIG. 6 we called it the “Norman” portfolio. Let us say one fund in it is called CLA 1105 CL Small Cap equity (Bisset) Gens with an average return of minus 21.84 and risk of 11.87%. Let's call it fund A to simplify things. By adding the fund to the portfolio, the fund will automatically appear as in FIG. 6 with the colors outlining the fundamental (grey which means that the R square for the fund was not available), Kolor™ (yellow), momentum (red) and risk management (red) buttons, as well as a pie chart for the fund describing the fund's asset allocation, along with its return (−21.84%) and risk of 11.87%. We can see the four colors of the fund outlining the four action buttons that are the fundamental (grey in cases where the data is not available), yellow because the fund has less return and less risk than the average return and risk of funds in that category or sector. The momentum button is red indicating that the fund has a negative momentum and the risk management button is also red, indicating that it is likely to lose more and recover more slowly than the average fund in that category or sector. Nobody else does this or provides such needed information.

However, by pressing the ‘add fund’ button on the bottom right hand side of FIG. 6, the user can easily add funds to the portfolio. And once the user has added the funds he/she wants either by code or by each fund's name, the user can easily seek to improve the portfolio on the left simply by pressing the ‘improve’ button.

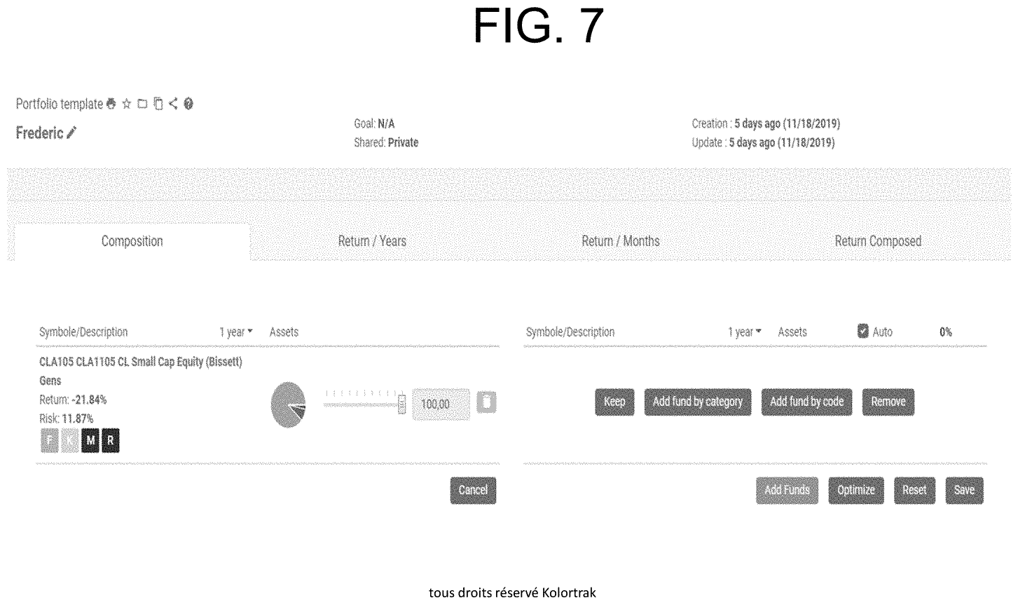

As shown in FIG. 7, by pressing the ‘improve’ button, the user will be provided with a new screen displaying potential new funds in the same categories as the current A fund in the Norman portfolio, but that will have a greater return and a smaller risk potential. The user may then select or let the system automatically select one or more fund(s) which will then be placed in a ‘new’ portfolio as seen on the right-hand side of the Norman portfolio, (right-hand side of the screen) but it will now be automatically be called “Normand improved”. The word “improved” will automatically be created on the right-hand side of the Norman portfolio.

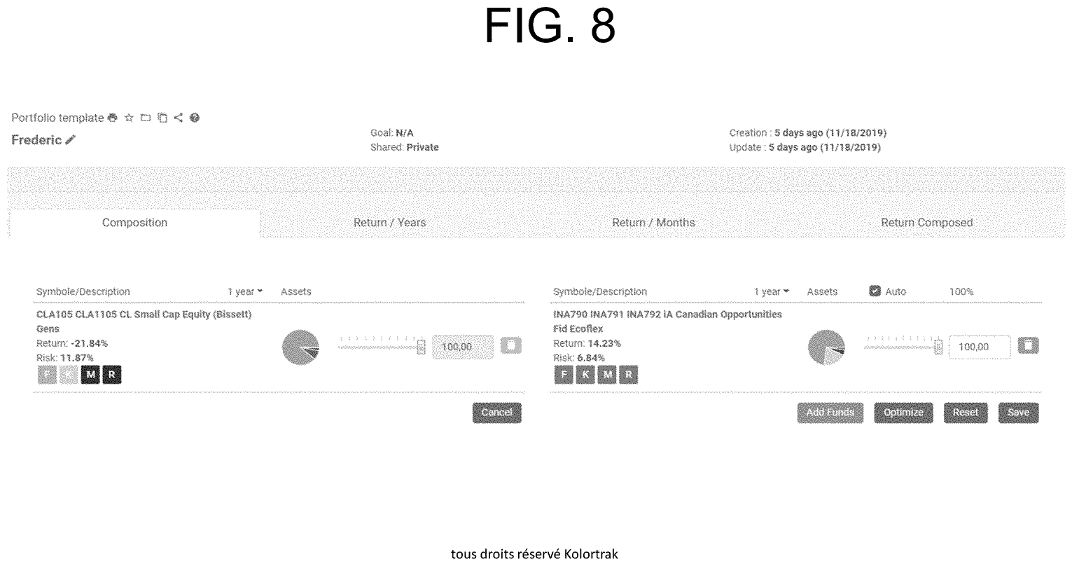

As shown in FIG. 8, at the right of the fund in the Norman portfolio side of the screen and beside the A fund and now underneath the “Norman improved” side, we will be able to read four additional action buttons like, “keep, add fund by category, add fund by code or remove”. If the user presses on the “keep” button, it will copy the original Norman A fund say onto the new “Norman improved” portfolio side.

If we press the keep button, the A fund on the left will automatically be transposed to the Norman improved portfolio. This is when we want to keep the A fund because we think it is a good performing fund.

If we press the “add fund by category” button it will bring us to the same category as the original A fund in the same risk/return category and will allow us to choose a new fund, let us say fund C, that has more return and less risk. In FIG. 8 the C fund is called INA790 INA 791 INA792 iA Canadian Opportunities FId Ecoflex with an average return of 14.23% and 6.84%. As you can easily see, the C fund has much more of a return potential and less risk than the A fund. That is the purpose of the ‘improve’ button, to find funds most often times in the same category as the A fund, but with more return and less risk. You will also note that the C fund has green colors for the fundamental, kolor, momentum and risk management buttons. This confirms that the C fund is much better than the A fund that has some red and yellow colors. The colors of the A fund indicate that it is a poor performing fund. We can confirm this new choice (fund C), by pressing the “save” button that has appeared on the risk return screen, this new fund C will automatically be inserted in the “Norman improved” portfolio on the right of the A fund that is being replaced. This new fund C, will have more return and less risk than the A fund, because we have chosen the C fund accordingly.

If the advisor is not happy with his choice of the C fund, he can press the “add fund by code” button and select a totally different fund, say fund “D”. The D fund that he prefers may be in another category (remember there are 56 different categories, and this is standard) but evidently it is one of his favorite funds that the financial advisor knows well. Evidently, this new fund will have more return and less risk than the A fund. That is the purpose of the exercise to enhance the A fund. Or by pressing the “add fund by code” button, the advisor may be able to replace the A fund by a term deposit, a treasury bond (and eventually) by a stock listed in the stock market or by the value of an income property such as an apartment building. This gives the advisor a lot of leeway in building his “Norman enhanced” portfolio that will perform better than the original A fund in the Norman portfolio. And evidently, since the new fund C, has more return and less risk than the A fund, the new Norman improved portfolio will fully respect the investors risk profile. What a blessing for the financial advisor. Nobody else uses this methodology.

And finally if the advisor does not want to replace the original fund A, for whatever reason such as there are already too many funds in the portfolio, he can press on the fourth button the “remove” button and that will totally suppress the A fund altogether and no new replacement for the A fund, will be included in the “Norman improved” portfolio. Why do this? Maybe the advisor thinks there are too many funds in the portfolio, or that it is too highly correlated with other funds in the portfolio, etc.

It normally takes an advisor about an hour and a half to do the above-mentioned operations using the normal way of doing things. But now with our invention, it can be easily done within about 10 to 15 minutes.

Moreover, we have a slider button that allows the advisor to balance his portfolio according to the investor's profile and asset composition. This button is completely new. Usually an advisor may spend another hour or hour and a half in order to choose the right proportions of stock funds and income funds that will correspond to the investors profile. He does this on a manual trial and error basis. However, by using the slider that is on the right hand of each fund in the “Norman improved” portfolio, he can slide the slider to the right and inverse the funds proportion in the portfolio) or to the left and decrease the funds proportion in the portfolio. And by using the slider for each fund, he will be able to see on the asset composition pie chart underneath the portfolio, the appropriate combination of each fund that is needed to meet the investors stock income ratio, the one that fits with his investor profile. This new balancing procedure takes about 2 or 3 minutes to do but saves up to another hour and a half of manual work, the traditional method in order to reach the appropriate balance.

The fund or portfolio that appeared is sent to the left and an identical portfolio is created automatically on the right with the same name but with the word “improved” added as an extension to the original portfolios name.

If you had say 10 funds in your original portfolio you could replace theses 10 funds by 10 other funds in their respective categories. By doing so you are building a new portfolio with much more return and less risk than the original. And you are respecting the investors investment profile because you are staying in the same categories for each fund, with less risk and more return. This is a winner very much appreciated by financial advisors.

What if the Asset Distribution Changes

Moreover, it may happen that the asset distribution has changed a bit because the new funds don't necessarily have the same composition of stocks or income or liquidity. Normally a financial advisor has to manually change the percent or monetary values of each fund and eventually end up with the appropriate asset distribution. This is called rebalancing. This can take a while of trial and error before getting the right distribution, But we simplify this by the use of a slider. Beside each fund there is a slider that can go from zero percent of the fund in the portfolio to 100 percent. Now if we have 5 funds in the portfolio, no one fund will have 0 percent in the portfolio and no one fund will have 100% of its weight in the portfolio. The slider allows us to add or subtract the percentage alloted to each of the five funds in order that the asset distribution of the portfolio matches that of the investors risk profile. Let us say that the distribution for an investor according to his risk profile should be 50% stocks and 50% bonds. If the portfolio that we have built gives us 70% stocks and 30% bonds, we are not respecting the investors risk profile. Normally an advisor will take two to three hours of trial and error in increasing the percentage of one or more funds and decreasing the percentage of some other funds until he comes up with the desired asset distribution. But with our slider, he can see instantly the effect of an increase in the percentage or monetary weight of one fund on the asset distribution. If the change the advisor has done does not go in the sense that is desired, he can change the weight of other funds and see instantly the effect on the asset distribution of the investors portfolio. Something that normally takes the advisor from one to two hours to do, can now be done in about two minutes with the slider.

That is why we can look at the slider on the right hand side of the new enhanced graphic. By sliding this back and forth manually we can create the same asset composition as in the original portfolio.

### The Optimize Button

The optimize button shown in FIG. 8 is another of our very much appreciated innovations. By pressing this button, in a matter of about 15 seconds, because we have developed an iterative methodology (a computer program that will do up to 10,000 simulations (trials and error) in about 15 seconds that will try different combinations of percentage weight of every fund in the portfolio and eventually come up with the combination of weights for each fund that will maximize the return and minimize the risk of the portfolio as a whole all the while respecting the investors asset distribution. It is as if an advisor was trying out manually different percentage contributions of the funds in the portgolio (in fact 10,000 tries) to come up with the best risk/return outcome. It would take an advisor weeks to do this manually. But only 15 seconds on an ordinary computer. Nobody else does this. 10,000 simulations that tend to find the best combinations of the funds that will maximize overall return, minimize overall risk while respecting the investors risk profile and asset distribution). No other firm offers this feature.

Normally, it takes between 2 to 3 hours for a financial advisor to set up an original fund, enhance it through normal trial and error and equilibrate it manually. But now, it can easily be done within about 15 minutes. We are saving a few hours per day in research, trial and error, etc. This gives the financial advisor ample time to go and play golf, or look after his family or go search for more prospects.

### The System and Method Backs Up Sales Arguments

We have about 30 arguments that an advisor user can evoke in order to convince a potential customer that some of the funds he/she currently possesses have limits (example its momentum is bad, the fund risks losing more than the average if the market crashes, that it will take much longer to recover than a normal fund in that category, that the fund has little room to increase, etc.). All of this is backed by data or measures that can be found in the system. When we added this feature, financial advisors confirmed that it had increased the conversion rate, increased the amount that prospective investors transfer over to the new advisor, and limited transfers out. Moreover the total approach allows users to improve on the return/risk ratios of their existing portfolios, which makes for greater customer satisfaction and more commissions for the advisor and the firm. Their commissions are usually based on the size of the total assets.

### Ways of Creating Leads

We have also added three different ways of creating leads that help enhance the financial advisors retention and conversion rates. One is through the use of an Apple or Google mobile application. Our system is the only one which can send the application that allows a prospective investor the chance to find if his/her funds are in the red, yellow, green or orange quadrants. The investor can then communicate with the advisor and continue the process with him/her. There is a special code in the mobile application that links the prospective investor with the investor.

### Our Calculation of the TMP Measures

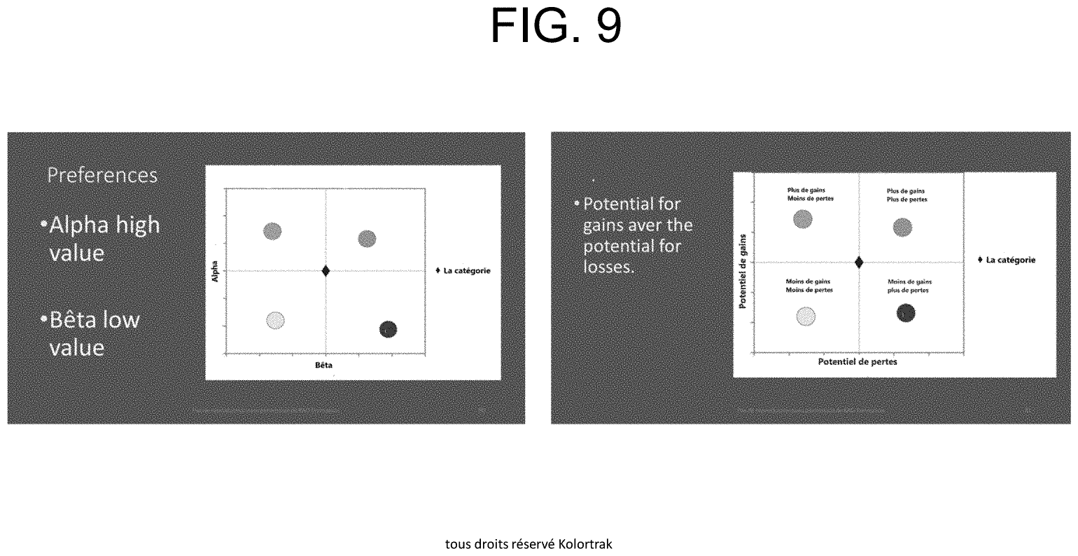

We calculate the values of TMP measures like alpha, beta, Treynor, etc. for each fund by using the variations of their respective categories rather than using the variations of the normal indices. Why are we innovating in this manner? At the time of writing this about 80% of funds have a coefficient of determination that is smaller than 85%. This means that the variations in the normal indices cannot explain significantly the variations in the alphas or betas, etc. of the funds. However, if we do these calculations with respect to a funds category (or main sector), we can have data that is more relevant and statistically significant for selecting, analyzing and evaluation funds than using indices. That has also allowed us to represent some of the data using the graphics as shown in FIG. 9. We have over 13 of them that are different, useful and easy to interpret (but not easy to calculate). They are also innovative and respect the quadrants with our four colors, making it easy for an advisor to interpret.

The invention helps advisors to analyze, evaluate, enhance and equilibrate better and faster. In order to beat its benchmark index, (which could be a category or sector) we need a value for alpha greater than zero, a beta smaller than one, a Treynor greater than 20, a Sharpe close to two and a percentage return as great as or greater than the benchmark index. This gives them time to play golf, take care of their families, or do some prospecting, and so on.

### Asymmetry

We have not invented the asymmetry measure, but we have adapted it in a risk management environment with funds (one of the variables in our risk management button). All fundamental approaches evaluate the risk or volatility of a fund with the notion of standard deviation. That is fine if standard deviations follow a normal curve. However, because of the disconnect of funds with their indices, standard deviations are not always normally distributed. That is why we use the notion of asymmetry, as a complementary measure of risk. If the asymmetry is greater than +,5 or less than −,5, the we must use asymmetry to evaluate the risk of funds and not the standard deviation. This is another measure that we have fitted in our system.

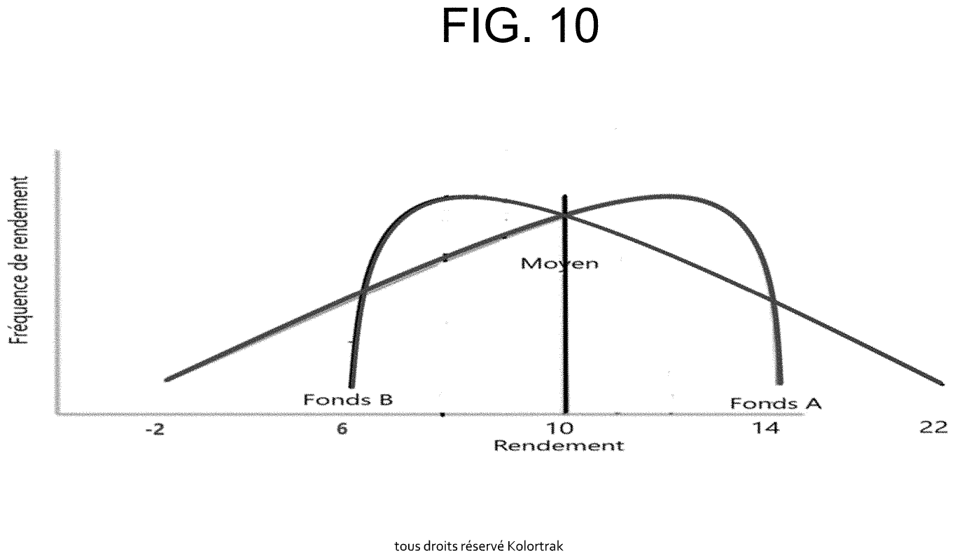

On the graphic shown in FIG. 10, we can see two funds with different asymmetries. Fund A has a negative asymmetry and fund B a positive one. Fund A will lose more than fund B in a down market but recover faster than Fund A. In a risk management button, we would prefer fund B.

### Putting Both the Median and the Average on a Risk/Return Graphic

One way to highlight this on a risk/return graphic, is to put both the median and the average on the same graphic. If the median is less than the average the fund has a positive asymmetry and that is what we are looking for.

A positive asymmetry is one or the distribution of returns, say, so that there are many low returns and some very high returns. We are better protected against a bear market, but we could take advantage of it during a bull market. Negative asymmetry is one or the distribution of returns, say, so that there are many relatively high yields and some very low returns. If the stock market falls, we risk losing much more than positive asymmetry and it may take longer to recover. Of two funds with equal average returns, positive asymmetry should be preferred.

You can see the invention at the following address www.kolortrak.com and try out the 5 day trial period or communicate with us (Guy Mineault 418 805 0701) and we can arrange for a longer period. If need be, we can also show you the innovative features and their functionalities via a software such as Teamviewer™ or Zoom™. We also have a three-hour seminar available in the system that allows the user to better understand how to navigate in the system as well as understand how to use it efficiently with investors.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1) A system for analyzing and evaluating the investment performance of funds or portfolios thereof comprising:
a) a risk/return graphic having four quadrants in which the lower right-hand quadrant depicts poor performing funds, the lower-left hand quadrant depicts better performing funds, the upper left-hand quadrant depicts the best overall performing funds and the upper-right hand quadrant depicts high risk and high return funds for people who are risk takers,
b) a dashboard comprising the following sections:
i) a risk/return section,
ii) a risk management section.

2) The system of claim 1) wherein one of a plurality of colors is associated to said risk/return section, said color being selected as follows:
a) a first predetermined color if the fund is located in the upper left-hand quadrant,
b) a second predetermined color if the fund is located in the lower right-hand quadrant,
c) a third predetermined color if the fund is located in the lower left-hand quadrant,
d) a fourth predetermined color if the fund is located in the upper right-hand quadrant.

3) The system of claim 2) wherein one of a plurality of colors is associated to said risk management section, said color being selected as follows:
a) a first predetermined color if the risk level is equal or lower than a first predetermined value,
b) a second predetermined color if the risk level is equal or greater than a second predetermined value,
c) a third predetermined color if the risk level is greater than said second predetermined value and lower than said first predetermined value.

4) The system of claim 3), further comprising a momentum/volatility section.

5) The system of claim 4) wherein one of a plurality of colors is associated to said momentum/volatility section, said color being selected as follows:
a) a first predetermined color if the Relative Strength Indicator is equal or lower than a third predetermined value,
b) a second predetermined color if the Relative Strength Indicator is equal or higher than a fourth predetermined value,
c) a third predetermined color if the Relative Strength Indicator is greater than said third predetermined value and lower than said fourth predetermined value.

6) The system of claim 5), further comprising a fundamental section.

7) The system of claim 6) wherein one of a plurality of colors is associated to said fundamental section, said color being selected as follows:
a) a first predetermined color if the coefficient of determination is equal or greater than a fifth predetermined value,
b) a second predetermined color if the coefficient of determination is equal or lower than a sixth predetermined value,
c) a third predetermined color if the coefficient of determination is greater than said sixth predetermined value and lower than said fifth predetermined value,

8) The system of claim 3) wherein the first color is green, the second color is red and the third color is yellow.

9) The system of claim 7) wherein the first color is green, the second color is red, the third color is yellow and the fourth color is orange.

10) A method for automatically analyzing and evaluating the investment performance of funds or portfolios thereof using a computer system comprising the following steps:
a) obtaining a plurality of data points from existing databases relating to each fund,
b) using the data points to compute the at least the following measures for each fund:
i) the coefficient of determination between said fund and its index of reference,
ii) its standard deviation,
iii) the value of its asymmetry,
iv) its relative strength indicator,
v) two of its moving averages,
vi) the rate of return,
c) generating a risk/return graphic having four quadrants in which the lower right-hand quadrant depicts poor performing funds, the lower-left hand quadrant depicts better performing funds, the upper left-hand quadrant depicts the best overall performing funds and the upper-right hand quadrant depicts high risk and high return funds for people who are risk takers,
d) generating a dashboard comprising the following sections:
i) a return/risk section,
ii) a risk management section,
e) assigning one of a plurality of colors to said return/risk section said color being selected as follows:
i) a first predetermined color if the fund is located in the upper left-hand quadrant,
ii) a second predetermined color if the fund is located in the lower right-hand quadrant,
iii) a third predetermined color if the fund is located in the lower left-hand quadrant,
iv) a fourth predetermined color if the fund is located in the upper right-hand quadrant.
f) assigning one of a plurality of colors to said risk management section, said color being selected as follows:
i) a first predetermined color if the risk level is equal or lower than a first predetermined value,
ii) a second predetermined color if the risk level is equal or greater than a second predetermined value,
iii) a third predetermined color if the risk level is greater than said second predetermined value and lower than said first predetermined value.

11) The method of claim 10), wherein the dashboard further comprises a momentum/volatility section and wherein one of a plurality of colors is associated to said momentum/volatility section, said color being selected as follows:
a) a first predetermined color if the Relative Strength Indicator is equal or lower than a third predetermined value,
b) a second predetermined color if the Relative Strength Indicator is equal or higher than a fourth predetermined value,
c) a third predetermined color if the Relative Strength Indicator is greater than said third predetermined value and lower than said fourth predetermined value.

12) The method of claim 11), wherein the dashboard further comprises a fundamental section and wherein one of a plurality of colors is associated to said fundamental section, said color being selected as follows:
a) a first predetermined color if the coefficient of determination is equal or greater than a fifth predetermined value,
b) a second predetermined color if the coefficient of determination is equal or lower than a sixth predetermined value,
c) a third predetermined color if the coefficient of determination is greater than said sixth predetermined value and lower than said fifth predetermined value,

13) The method of claim 10) wherein the first color is green, the second color is red and the third color is yellow.

14) The method of claim 12), wherein the first predetermined value of the coefficient of determination is 85%.

15) The method of claim 10), wherein at least 11 measures selected from the following are computed:
a) alpha ratio,
b) beta coefficient,
c) Treynor ratio,
d) Calmar ratio,
e) Sharpe ratio,
f) liquidity ratios,
g) information ratio,
h) quartile of price/earnings,
i) quartile of price to book ratio,
j) rotation ratio,
k) quartile of standard deviation,
l) the value of the asymmetry,
m) the value of the kurtosis,
n) the value of the fund in the last three-year interval,
o) the number of stocks in the fund,
p) a recovery ratio,
q) the funds Sharpe ratio divided by the Sharpe ratio of the fund's category or sector.

16) The method of claim 15), wherein the first value and second value are determined by adding the number of selected measures which indicate the fund is more at risk than the average in its category or sector.

17) The method of claim 16), wherein the first value is 4 and the second value is 8.
